(19) United States
(12) Patent Application Publication
(10) Pub. No.: US 2015/0277520 A1
(43) Pub. Date: Oct. 1, 2015

(54) TEMPERATURE REGULATION OF A CPU

(71) Applicant: HEWLETT-PACKARD DEVELOPMENT COMPANY, L.P., Houston, TX (US)

(72) Inventor: Matthew Neumann, Roseville, CA (US)

(21) Appl. No.: 14/432,193

(22) PCT Filed: Sep. 28, 2012
(86) PCT No.: PCT/US2012/058097

§ 371 Date: Mar. 27, 2015

(51) Int. Cl. G06F 1/20; G06F 11/30; G06F 1/32

(52) U.S. Cl. CPC G06F 1/206; G06F 1/3206; G06F 1/3234; G06F 11/3024; G06F 11/3058

(57) ABSTRACT

A method to regulate a temperature of a central processing unit is provided herein. The method monitors a temperature of a central processing unit. The method obtains a power state of the central processing unit and a fan speed of a fan associated with the central processing unit. The temperature of the central processing unit is decreased by reducing the power state, in response to a determination that the temperature is at least one of equal to or greater than the predefined temperature threshold; the fan speed is at least one of equal to or greater than a maximum speed threshold; and the power state is greater than a lowest power state threshold.

### BACKGROUND

A central processing unit operates best within a predefined temperature range. Operation of the central processing unit outside of the predefined temperature range may result in data loss or corruption, i.e., loss of data integrity.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a control module usable with a central processing unit to regulate a temperature of the central processing unit;

FIGS. 2-3 illustrate block diagrams of systems to regulate a temperature of a central processing unit according to examples;

FIG. 4 illustrates an apparatus to regulate a temperature of the central processing unit according to an example;

FIG. 5 illustrates a flow chart of a method to regulate a temperature of a central processing unit according to an example; and

FIG. 6 illustrates a flow chart of a process, usable with the method of FIG. 5, to regulate a temperature of a central processing unit according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

A central processing unit operates best within a predefined temperature range. Increase in the temperature of the central processing unit above the predefined temperature range typically causes a reduction of processor speed and workload of the processor in efforts to decrease the temperature of the processor. A central processing unit typically throttles at a specific temperature to reduce power and reduce temperature. For example, the central processing unit moves between a maximum power state or frequency to a minimum power state or frequency. The movement between maximum and minimum power state dramatically changes the temperature of the central processing unit and the performance or workload of the central processing unit. The dramatic change, specifically the spike in power between a minimum power state and a maximum power state, introduces the risk of data loss and/or corruption of data due to the rise in the power state and the rapid temperature increase associated therewith.

In examples, a method to regulate a temperature of a central processing unit is provided. The method monitors a temperature of a central processing unit. The method obtains a power state of the central processing unit and a fan speed of a fan associated with the central processing unit. The temperature of the central processing unit is decreased by reducing the power state, in response to a determination that the temperature is at least one of equal to or greater than the predefined temperature threshold; the fan speed is at least one of equal to or greater than a maximum speed threshold; and the power state is greater than a lowest power state threshold. The method regulates the temperature using gradual reduction to the power state only if the speed of the fan is at a maximum speed threshold.

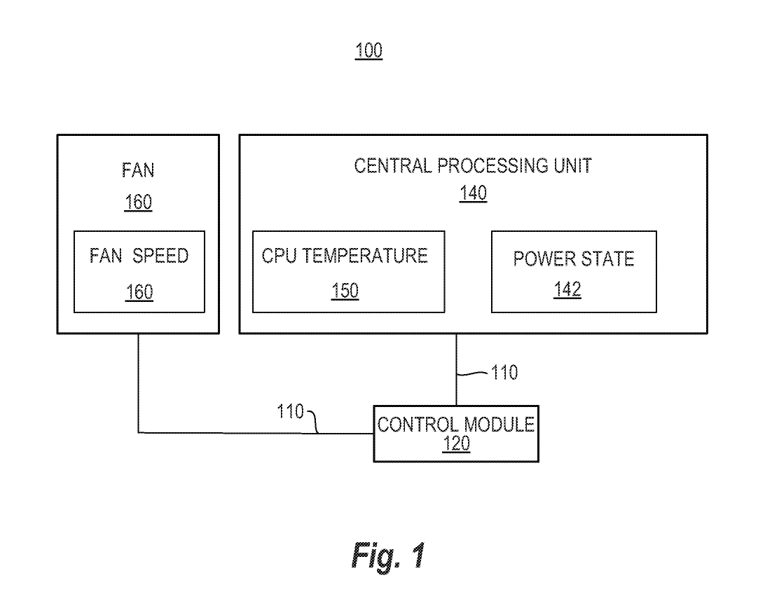

FIG. 1 illustrates a control module 120 usable with a central processing unit 140 to regulate a temperature of the central processing unit 140. The control module 120 is, for example, part of an apparatus that regulates the temperature of a central processing unit 140. The control module 120 incrementally reduces a power state 142 of a central processing unit 140 based on a CPU temperature 150 and further determinations of the environment of a system 100. For example, the control module 120 will first increase fan speed 162, or a speed 162 of the fan 160, when the CPU temperature 150, or temperature 150 of the central processing unit 140, is at least one of equal to or greater the predefined temperature threshold and the fan speed 162 is less than a maximum fan speed threshold. The control module 120 determines that the CPU temperature 150 is at least one of equal to or greater than a predefined temperature threshold by, for example, comparing the temperature of the central processing unit to a predefined temperature threshold.

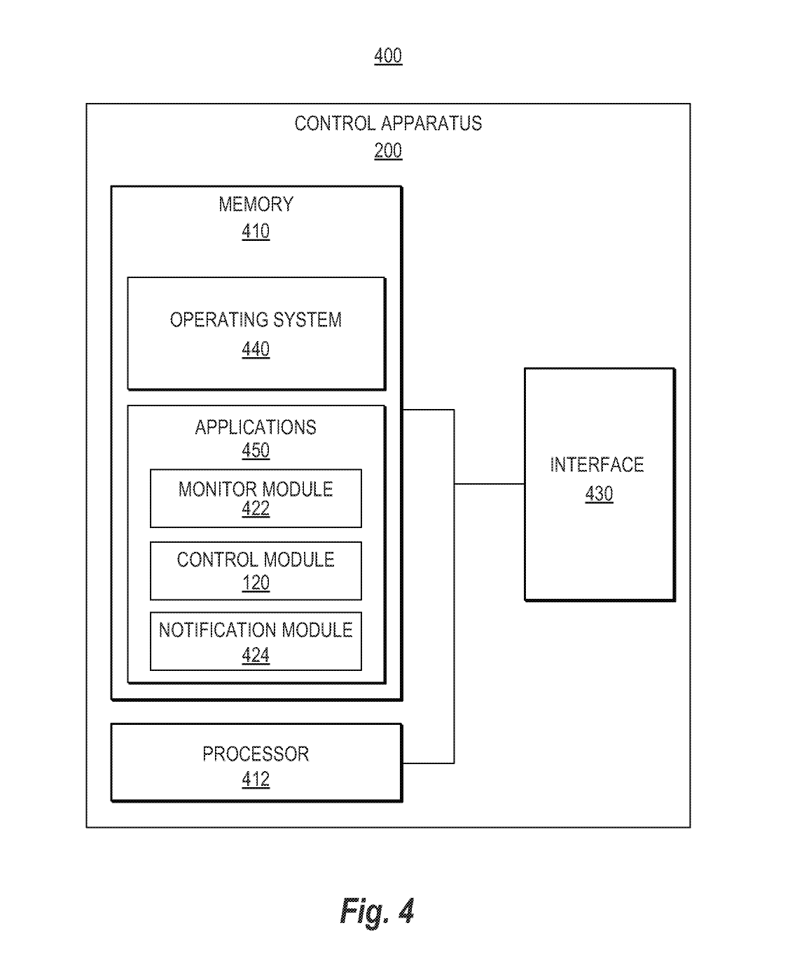

The control module 120 is linked 110 to the central processing unit 140 and a fan 160 associated with the central processing unit 140. The control module 120 incrementally reduces the power state 142, such that the reduction of the power state 142 includes reducing the power state 142 by one tick, i.e., eleven to twelve Watts per tick, in response to the following determinations. First, the CPU temperature 150 is at least one of equal to or greater than a predefined temperature threshold. Second, the power state 142 is at least one of equal to or greater than a lowest power state threshold. Third, a fan speed 162 is at least one of equal to or greater than a maximum speed threshold. The control module 120 may obtain the CPU temperature 150, the power state 142, and the fan speed 162 via, for example, a monitor module (illustrated in FIG. 4) also linked to the control module 120.

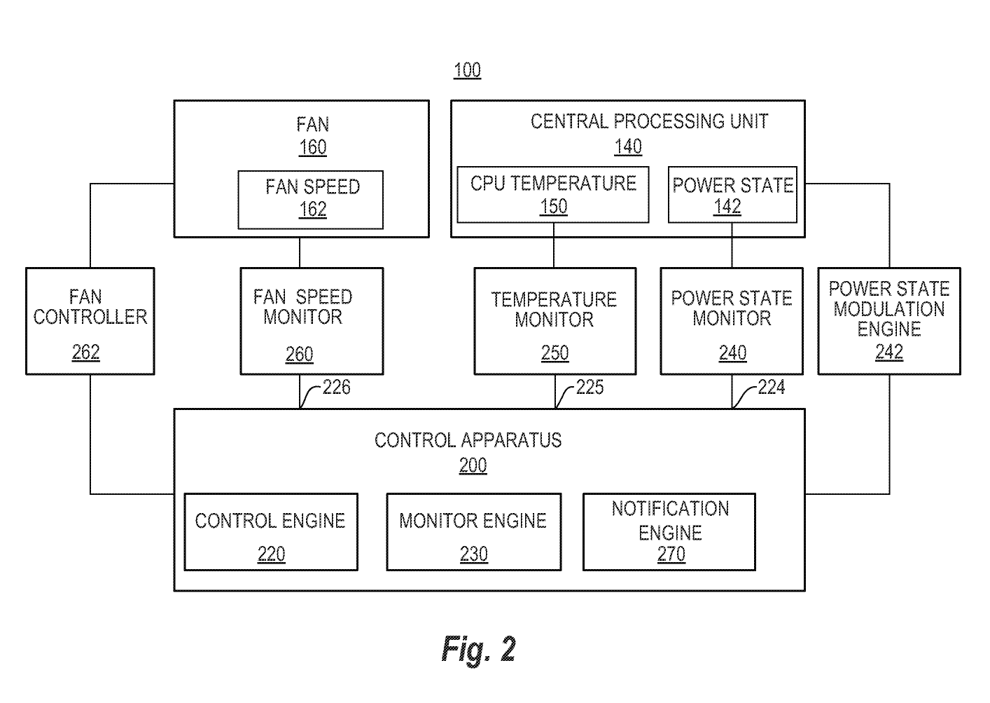

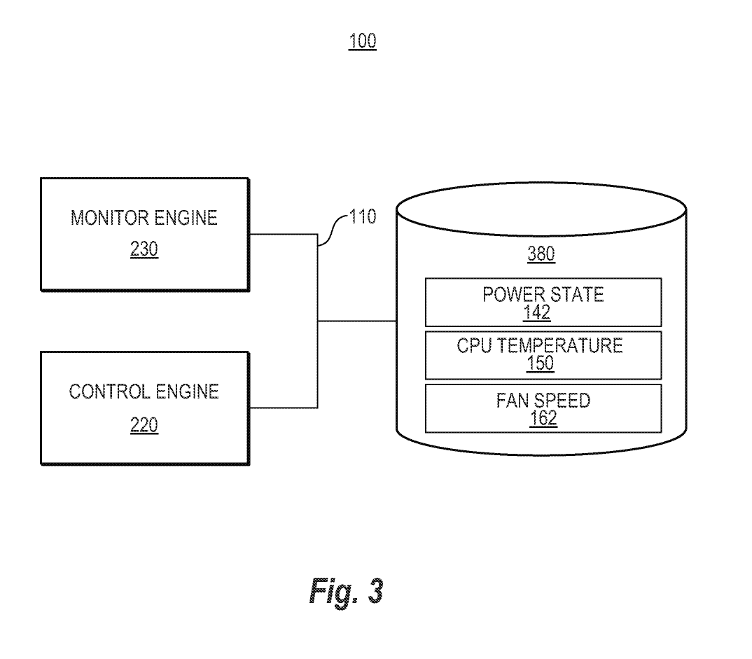

FIGS. 2-3 illustrate block diagrams of systems 100 to regulate a temperature of a central processing unit 140 according to examples. The systems 100 include a control engine 220 and a monitor engine 230. Referring to FIG. 2, the control engine 220 and the monitor engine 230 are, for example, part of a control apparatus 200 that is linked 110 to a central processing unit 140 and a fan 160. The control apparatus 200 receives the power state 142, the CPU temperature 150, and/or the fan speed 162 as, for example, a power input 224, a temperature input 225, and a speed input 226. The monitor engine 230 obtains the CPU temperature 150, the speed 162 the fan 160, and the power state 142 of the central processing unit 140. For example, the monitor engine 230 obtains the power state 142 by polling the central processing unit 140 for the power state 142, using for example, a power state monitor 240. The monitor engine 230 is illustrated to also obtain the CPU temperature 150 using, for example, a temperature monitor 250 or a thermal sensor on the central processing unit 140 and the fan speed 162 using a fan speed monitor 260.

The control engine 220 uses the CPU temperature 150, the speed 162, and the power state 142 to determine when to reduce the power state 142. The system 100 is further illustrated to include a power state modulation engine 242 connected to the control engine 220 to incrementally reduce the power state 142. The control engine 220 reduces the power state 142, in response to the following determinations. First, the CPU temperature 150 is outside of a predefined temperature range. Second, the fan speed 162 is at least one of equal to or greater than a maximum speed threshold. Third, the power state 142 is greater than a lowest power state threshold.

The system 100 first increases the fan speed 162 using, for example, a fan controller 262, in response a determination that the CPU temperature 150 is outside of the predefined temperature range and the fan speed 162 is less than a maximum speed threshold. Increasing the fan speed 162 provides an advantage, as the power state 142 of the central processing unit 140 is not exposed to large power spikes, such as drastic changes in power between minimum power state and a maximum power state. Preventing the large power spikes reduces the risk of data loss and/or corruption of data due to the rise in the power state and the rapid temperature increase associated therewith. Moreover, when the control engine 220 determines that the power state 142 of the central processing unit 140 should be reduced, the control engine 220 incrementally or gradually reduces the power state 142, which also reduces the risks involved in reducing the power state 142. For example, incremental or gradual reductions in power states 142 prevent dramatic changes in the power state 142; however, the ability to incrementally or gradually reduce the power state 142 does not occur during throttling and as provided herein is performed using the control engine 220, such as firmware.

The control apparatus 200 is further illustrated to include a notification engine that generates a thermal warning 272 in response to the following determinations. First, the CPU temperature 150 is outside of the predefined temperature range. Second, the fan speed 162 is at least one of equal to or greater than the maximum speed threshold. Third, the power state 142 is at least one of equal to or less than the lowest power state threshold. For example, the notification may be aid in notifying or alerting a user that manual operations, such as a soft shutdown is necessary to preserve the data and prevent data loss due to the CPU temperature 150. Alternatively, the notification may be provided for notice when one or more of the above determinations are not satisfied, but the user requests a log or record of possible thermal events. For example, the log or record includes steps that have been taken to prevent thermal events, such as increasing the fan speed 162 and/or reducing the power state 142 by one tick.

Referring to FIG. 3, the system 100 is further illustrated to include a data store 380 connected to the control engine 220 and the monitor engine 230 via the link 110. The monitor engine 230 represents generally a combination of hardware and/or programming that obtains the CPU temperature 150, the power state 142, and the fan speed 162. For example, as illustrated in FIG. 2, the monitor engine 230 obtains the power state 142 by polling the central processing unit 140 for the power state 142, using for example, a power state monitor 240. The monitor engine 230 is illustrated to also obtain the CPU temperature 150 using, for example, a temperature monitor 250 or temperature sensor on the central processing unit 140, and the fan speed 162 using, for example, a fan speed monitor 260.

The control engine 220 represents generally a combination of hardware and/or programming that reduces the power state 142, in response to a determination. For example, control engine 220 incrementally reduces the power state 142, such that the power state 142 is reduced by one tick, for example, eleven to twelve Watts per tick. The control module determines when to reduce the power state 142 using the following determinations. First, the CPU temperature 150 is outside of a predefined temperature range. Second, the fan speed 162 is at least one of equal to or greater than a maximum speed threshold. Third, the power state 142 is greater than a lowest power state threshold.

The data store 380 represents generally any memory configured to store data accessible by the control engine 220 and/or the monitor engine 230 in the performance of its function. The data store 380 is, for example, a database that stores the power state 142, the CPU temperature 150, and/or the fan speed 162.

The control engine 220 functionalities are accomplished via the link 110 that connects the control engine 220 to the monitor engine 230, and the data store 380. The link 110 represents generally one or more of a cable, wireless, fiber optic, or remote connections via a telecommunication link, an infrared link, a radio frequency link, or any other connectors or systems that provide electronic communication. The link 110 includes, at least in part, an intranet, the Internet, or a combination of both. The link 110 may also include intermediate proxies, routers, switches, load balancers, and the like.

The control apparatus 200 further includes a notification engine 270 that represents generally a combination of hardware and/or programming that generates a notification. For example, the notification is generated in response to a determination of the following. First, the CPU temperature 150 is at least one of equal to or greater than the predefined temperature threshold. Second, the fan speed 162 is at least one of equal to or greater than the maximum speed threshold. Third, the power state 142 at least one of equal to or less than a lowest power state threshold. Manual actions, such as soft shutdown of a system may occur as a result of the notification. The soft shut down, which is typically performed manually, will prevent data loss or data corruption due to the increase in the CPU temperature 150. The notification may be used as a “last resort” as the control apparatus 200 is designed to automate reduction of the CPU temperature 150; however, the notification may alternatively be a reporting process and that generates a notification when at least one of the above determinations are not satisfied. For example, the log or record includes steps that have been taken to prevent thermal events, such as increasing the fan speed 162 and/or reducing the power state 142 by one tick.

The notification engine 270 is illustrated in AG. 2 as a separate engine; however, the control engine 220, monitor engine 230, and/or a notification engine 270 may individually or in combination perform the functions that generate the notification.

FIG. 4 illustrates an apparatus to regulate a temperature of the central processing unit according to an example. The control apparatus 200, for example, includes firmware or a computer readable medium 400 that regulates the temperature 142 of the central processing unit 140. The apparatus regulates the temperature 142 when the fan speed 162 is at a maximum speed threshold and the fan controller is not sufficient to regulate the temperature of the central processing unit 140 due to the environment surrounding the central processing unit 140 and/or processing demands.

In FIG. 4, the monitor apparatus 200 is illustrated to include a memory 410, a processor 412, and an interface 430. The memory 410 stores a set of instructions. The processor 412 is coupled to the memory 410 to execute the set of instructions. The processor 412 represents generally any processor configured to execute program instructions stored in memory 410 to perform various specified functions. The interface 430 represents generally any interface enabling the monitor apparatus 200 to communicate with the central processing unit 140 and/or a notification device via the link 110, as illustrated in FIGS. 1-3.

The memory 410 is illustrated to include an operating system 440 and applications 450. The operating system 440 represents a collection of programs that when executed by the processor 412 serves as a platform on which applications 450 run. Examples of operating systems 440 include various versions of Microsoft's Windows® and Linux®. Applications 450 represent program instructions that when executed by the processor 412 function as an application that when executed by a processor 412 regulate the temperature of a central processing unit 140.

For example, FIG. 4 illustrates a monitor module 422 and a control module 120 as executable program instructions stored in memory 410 of the monitor apparatus 200. The monitor module 422, when executed obtains the CPU temperature 150, the power state 142, and the fan speed 162. For example, the set of instructions obtain the power state 142 from a poll of the central processing unit 140; obtain the CPU temperature 150 from a temperature monitor 250 or a temperature sensor on the central processing unit 140; and obtain the fan speed 162 from a fan speed monitor 260. The control apparatus 200 receives the power state 142, the CPU temperature 150, and/or the fan speed 162 as, for example, a power input 224, a temperature input 225, and a speed input 226, as illustrated in FIG. 2.

The control module 120, when executed reduces the power state 142, in response to a determination. For example, the set of instructions incrementally or gradually reduces the power state 142, such that the power state 142 is reduced by one tick, for example, eleven to twelve Watts per tick. The control module 120 determines when to reduce the power state 142 using the following determinations. First, the CPU temperature 150 is at least one of equal to or greater than a predefined temperature threshold. Second, the power state 142 is at least one of equal to or greater than a lowest power state threshold. Third, a fan speed 162 is at least one of equal to or greater than a maximum speed threshold.

The set of instructions also generate a notification. For example, the notification module 424 generates the notification in response to the following determinations. First, the CPU temperature 150 is at least one of equal to or greater than the predefined temperature threshold. Second, the fan speed 162 is at least one of equal to or greater than the maximum speed threshold. Third, the power state 142 at least one of equal to or less than a lowest power state threshold. Manual actions, such as soft shutdown of a system may occur as a result of the notification. The soft shut down, which is typically performed manually, will prevent data loss or data corruption due to the increase in the CPU temperature 150. The notification may be used as a “last resort” as the control apparatus 200 is designed to automate reduction of the CPU temperature 150; however, the notification may alternatively be a reporting process and that generates a notification when at least one of the above determinations are not satisfied. For example, the log or record includes steps that have been taken to prevent thermal events, such as increasing the fan speed 162 and/or reducing the power state 142 by one tick.

Referring back to FIGS. 2-3, the control engine 220 and the monitor engine 230 of the control apparatus 220 are described as combinations of hardware and/or programming. As illustrated in FIG. 4, the hardware portions include the processor 412. The programming portions include the operating system 440, applications 450, and/or combinations thereof. For example, the monitor module 422 represents program instructions 389 that when executed by a processor 412 cause the implementation of the of the monitor engine 230 of FIGS. 2-3. The control module 120 represents program instructions 389 that when executed by a processor 412 cause the implementation of the of the control engine 220 of FIGS. 2-3. Similarly, the functions of the notification engine 270 are performed by the monitor module 422, the control module 120, and/or the notification module 424 or by additional module(s) (not shown).

The programming of the monitor module 422 and control module 120 may be processor 412 executable instructions stored on a memory 410 that includes a tangible memory media and the hardware include a processor 412 to execute the instructions. The memory 410 may store program instructions that when executed by the processor 412 cause the processor 412 to perform the program instructions. The memory 410 is integrated in the same device (or system) as the processor 412 or it is separate but accessible to that device (or system) and processor 412.

In some examples, the program instructions may be part of an installation package that can be executed by the processor 412 to perform a method using the system 100. The memory 410 is a portable medium such as a CD, DVD, or flash drive or a memory maintained by a server from which the installation package can be downloaded and installed. In some examples, the program instructions may be part of an application or applications already installed on a computing device, In further examples, the memory 410 includes integrated memory, such as a hard drive.

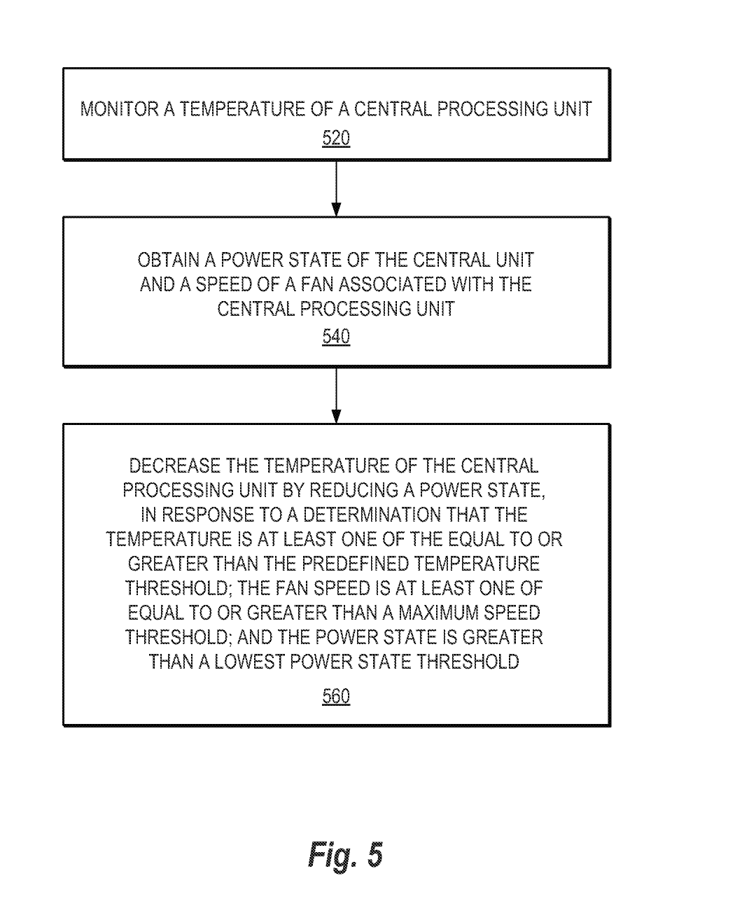

FIG. 5 illustrates a flow chart 500 of a method to regulate a temperature of a central processing unit according to an example. In block 520, monitors a temperature of a central processing unit by comparing the temperature to a predefined temperature threshold. A power state of the central processing unit and a fan speed of a fan associated with the central processing unit are obtained in block 540. The power state is obtained by, for example, a poll of the central processing unit. In block 560, the temperature of the central processing unit is decreased by reducing the power state. The power state is reduced in response to a determination of the following. First, the CPU temperature is at least one of equal to or greater than the predefined temperature threshold. Second, the fan speed is at least one of equal to or greater than a maximum speed threshold. Third, the power state is greater than a lowest power state threshold

The method is designed to increase the speed of the fan or fan speed using, for example a fan controller, when the temperature of the central processing unit or CPU temperature is at least one of equal to or greater than the predefined temperature threshold and the fan speed is less than a maximum speed threshold. The increase in the fan speed occurs prior to decreasing the power state of the central processing unit, using the control module that includes, for example, firmware. Moreover, the method also generates a thermal warning in response to a determination that the CPU temperature is at least one of equal to or greater than the predefined temperature threshold and the power state is at least one of equal to or less than the lowest power state threshold.

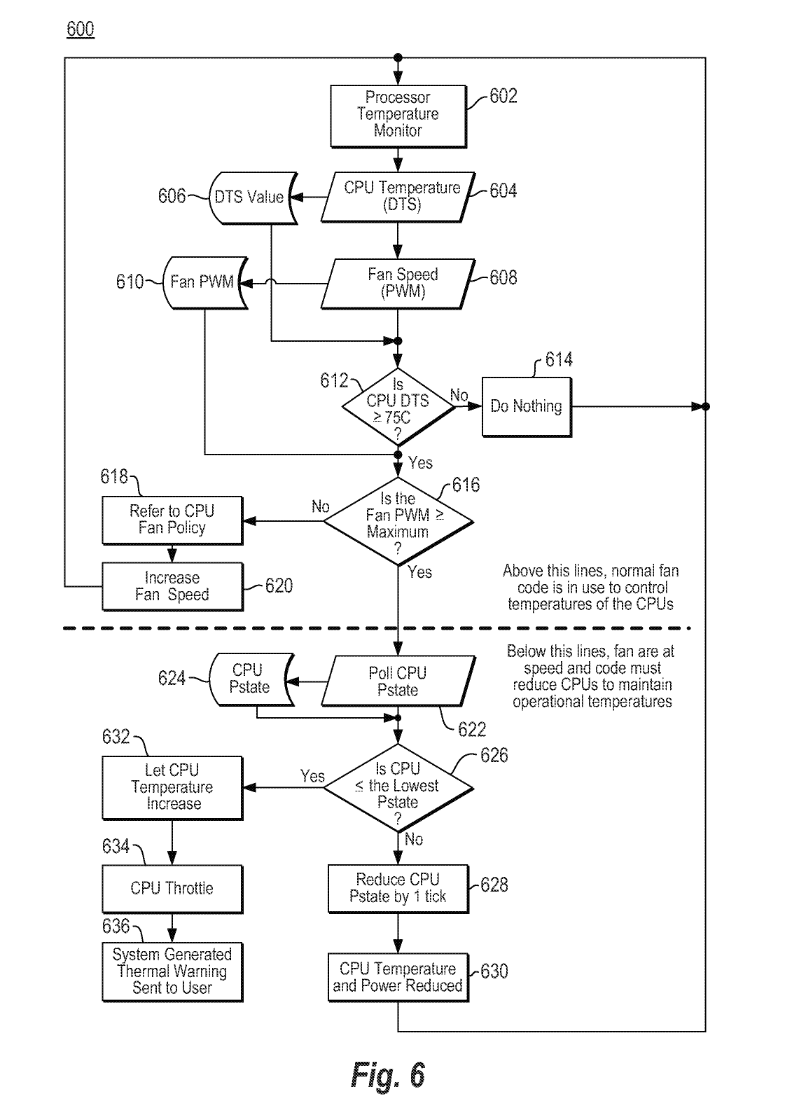

FIG. 6 illustrates a flow chart of a process 600 to regulate a temperature of a central processing unit according to an example. The process 600 begins in block 602, with initialization of a processor temperature monitor. The CPU temperature reading is obtained in block 604 and saved as a digital thermal sensor (DTS) value in block 606. The fan speed is obtained in block 608. The fan speed is saved as a pulse width modulation (PWM) value in block 610.

After the CPU temperature reading and fan speed are obtained, the CPU temperature or DTS value from block 606 is compared to a predefined temperature threshold in block 612. For example, the predefined temperature threshold includes a DTS value greater than or equal to seventy-five degrees Celsius. A determination that the CPU temperature is less than or lower than the predefined temperature threshold, results in the process doing “nothing” in block 614, as the CPU temperature is within an acceptable range. For example, the fan speed and the power state of the CPU do not need to be changed. The process 600 returns to block 602 and continues to monitor the CPU temperature by repeating the above process.

Alternatively, a determination that the CPU temperature is equal to or greater than the predefined temperature threshold, results in the process determining if the fan speed is equal to or greater than a maximum speed threshold in block 616, using the saved speed from block 610. A determination that the fan speed is not equal to or greater than the maximum speed threshold results in the process 600 referring to a fan process in block 618, which will increase the fan speed according to block 620. The process 600 then returns to block 602 and continues to monitor the CPU temperature by repeating the above process.

In a further alternative, a determination that the fan speed is equal to or greater than the maximum speed threshold in block 618, results in a poll of the power state of the central processing unit in block 622. The power state is saved in block 624 and used in block 626 to determine if the power state is at least equal to the lowest power state threshold. A determination that the power state is greater than the lowest power state threshold in block 626 results in the power state being reduced in block 628. For example, block 628 incrementally or gradually reduces the power state by one tick, i.e., eleven to twelve Watts per tick. Previous processes throttle the central processing unit between a maximum and a minimum power state, instead of incrementally or gradually reduce the power state. The throttling provides drastic changes in processing power, such as moving from a minimum power state to a maximum power state. Throttling causes quick spikes and drops in power and temperature. The drastic changes in processing power and temperature, especially spikes in power which cause the CPU temperature to rapidly rise, increase the risk of data loss and/or data corruption. In contrast, the method provided herein gradually reduces the power state, which results in the gradual reduction of temperature of the central processing unit in block 630. For example, reducing the power state may decrease the temperature of the central processing unit by one or two degrees Celsius. The process 600 then returns to block 602 and continues to monitor the CPU temperature by repeating the above process.

In yet another alternative, a determination that the power state is at least equal to the lowest power state threshold in block 626 results in no change in the power state in block 632, which results in letting the CPU temperature increase. The increase in the CPU temperature in block 632 causes the central processing unit to throttle in block 634 and a notification is generated that provides a thermal warning to a user in block 636. The notification provides an alert for a user to take manual actions, such as a soft shutdown of the system, which reduces the risk of data loss and/or data corruption.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. An apparatus to regulate a temperature of a central processing unit, the apparatus comprising:
a monitor module to obtain
the temperature of the central processing unit,
a power state of the central processing unit, and
a speed of a fan associated with the central processing unit; and
a control module to incrementally reduce the power state, in response to a determination that:
the temperature is at least one of equal to or greater than a predefined temperature threshold,
the power state is at least one of equal to or greater than a lowest power state threshold, and
the speed of the fan is at least one of equal to or greater than a maximum speed threshold.

2. The apparatus of claim 1, wherein the control module incrementally reduces the power state by reducing the power state by one tick.

3. The apparatus of claim 1, wherein the control module determines the temperature is at least one of equal to or greater than a predefined temperature threshold by comparing the temperature of the central processing unit to a predefined temperature threshold.

4. The apparatus of claim 1, wherein the control module increases the speed of the fan when the temperature of the central processing unit is at least one of equal to or greater than the predefined temperature threshold and the speed of the fan is less than a maximum fan speed.

5. The apparatus of claim 1, further comprising:
a temperature input to receive the temperature of the central processing unit;
a speed input to receive the speed of the fan; and
a power input to receive the power state of the central processing unit.

6. The apparatus of claim 1, wherein the monitor module generates a notification in response to a determination that:
the temperature is at least one of equal to or greater than the predefined temperature threshold;
the speed is at least one of equal to or greater than the maximum speed threshold; and
the power state at least one of equal to or less than a lowest power state threshold.

7. A system to regulate a temperature of a central processing unit, the system comprising:
a monitor engine to obtain:
the temperature of a central processing unit;
a speed of a fan; and
a power state of the central processing unit; and
a control engine to:
reduce the power state, in response to a determination that:
the temperature is outside of a predefined temperature range;
the speed is at least one of equal to or greater than a maximum speed threshold; and
the power state is greater than a lowest power state threshold.

8. The system of claim 7, wherein the monitor engine obtains the power state by polling the central processing unit for the power state.

9. The system of claim 7, further comprising a power state modulation engine connected to the control engine to incrementally reduce the power state.

10. The system of claim 7, wherein the control engine increases the speed of the fan in response to a determination that:
the temperature of the central processing unit is outside of the predefined temperature range, and
the speed of the fan is less than a maximum speed threshold.

11. The system of claim 7, further comprising a notification engine to generate a thermal warning in response to a determination that:
the temperature of the central processing unit is outside of the predefined temperature range,
the speed is at least one of equal to or greater than the maximum speed threshold, and
the power state is at least one of equal to or less than the lowest power state threshold.

12. A method to regulate a temperature of a central processing unit, the method comprising:
monitoring a temperature of a central processing unit by comparing the temperature to a predefined temperature threshold;
obtaining a power state of the central processing unit and a fan speed of a fan associated with the central processing unit;
decreasing the temperature of the central processing unit by reducing the power state, in response to a determination that
the temperature is at least one of equal to or greater than the predefined temperature threshold;
the speed is at least one of equal to or greater than a maximum speed threshold; and
the power state is greater than a lowest power state threshold.

13. The method of claim 12, further comprising generating a thermal warning in response to a determination that the temperature of the central processing unit is at least one of equal to or greater than the predefined temperature threshold and the power state is at least one of equal to or less than the lowest power state threshold.

14. The method of claim 12 further comprising:
increasing the speed of the fan when the temperature of the central processing unit is at least one of equal to or greater than the predefined temperature threshold and the speed of the fan is less than a maximum speed threshold.

15. The method of claim 12, further comprising determining the power state by polling the central processing unit.
